(19) United States
(12) Patent Application Publication
(10) Pub. No.: US 2026/0136437 A1
(43) Pub. Date: May 14, 2026

(54) Electric Heating Apparatus and Cooking Device

(71) Applicant: ZHONGSHAN JINWEN ELECTRICAL APPLIANCE INDUSTRIAL CO., LTD., Zhongshan (CN)

(72) Inventors: Chunxiu Zou, Zhongshan (CN); Jingwen Deng, Zhongshan (CN); Jinfei Li, Zhongshan (CN); Wang Zhu, Zhongshan (CN)

(21) Appl. No.: 19/003,117

(22) Filed: Dec. 27, 2024

(30) Foreign Application Priority Data
Nov. 11, 2024 (CN) 202411600873.6

(51) Int. Cl. H05B 3/32; H05B 3/02

(52) U.S. Cl. CPC H05B 3/32; H05B 3/02

(57) ABSTRACT

An electric heating apparatus and a cooking device are disclosed. The electric heating apparatus includes a heating element, a mounting base, a temperature limiter and a first heat insulation member, where a middle part of the heating element is provided with a mounting position, the mounting base is disposed at the mounting position and has a mounting inner cavity, an upper side cover of the mounting base is provided with an upper cover body, the temperature limiter is fixedly connected to the upper cover body or the mounting base, the upper cover body is provided with an avoidance hole corresponding to the temperature limiter, the temperature limiter is partially positioned in the mounting inner cavity and partially extends above the upper cover body through the avoidance hole, and the first heat insulation member is disposed at the mounting position and positioned between the heating element and the upper cover body.

### CROSS-REFERENCE TO RELATED APPLICATIONS

This application claims priority to Chinese Patent Application No. 202411600873.6 filed November 11, 2024, the disclosure of which is hereby incorporated by reference in its entirety.

### BACKGROUND

### TECHNICAL FIELD

The present disclosure relates to the technical field of kitchen appliances, and in particular, to an electric heating apparatus and a cooking device.

### TECHNICAL CONSIDERATIONS

Some existing cooking devices such as electric woks and electric frying pans are usually equipped with temperature limiters to control their temperatures. Specifically, an electric heating apparatus is provided in the housing of the cooking device, and the electric heating apparatus usually includes a disk-shaped heating element. A mounting position is provided at the center of the disk-shaped heating element, and a cover body is provided in the mounting position. The temperature limiter is positioned in the mounting position and covered by the cover body for being shielded. The temperature limiter is electrically connected with the heating element. When in use, the temperature limiter is used to detect the temperature of the cooking cavity of the cooking device. The temperature limiter will cut off the power of the heating element when detecting that the temperature reaches the preset safety threshold, to prevent the cooking device from overheating and leading to a fire. However, for this electric heating apparatus, the temperature detected by the temperature limiter may be different from the actual temperature of the cooking cavity due to the obstruction of the cover body, which will affect the accuracy of temperature detection. Moreover, if the cover body is removed, the temperature of the heating element around the cover body may also interfere with the temperature detection of the temperature limiter and affect the normal work of the temperature limiter.

### SUMMARY

The present disclosure aims to solve at least one of the technical problems existing in the existing technology. To this end, an electric heating apparatus is provided herein, a temperature limiter thereof is capable of extending above an upper cover body for temperature detection, which is beneficial to improving the accuracy of temperature detection, and is capable of reduce the interference of a heating member on the temperature limiter by a first heat insulation member, and is helpful to ensure the normal work of the temperature limiter.

A cooking device with the electric heating apparatus is further provided herein.

The electric heating apparatus according to a non-limiting embodiment in a first non-limiting aspect of the present disclosure includes a heating element, a mounting base, a temperature limiter and a first heat insulation member, where a middle part of the heating element is provided with a mounting position, the mounting base is disposed at the mounting position and equipped with a mounting inner cavity, an upper side cover of the mounting base is provided with an upper cover body, the temperature limiter is fixedly connected to the upper cover body or the mounting base, the upper cover body is provided with an avoidance hole corresponding to the temperature limiter, the temperature limiter is partially positioned in the mounting inner cavity and partially extends above the upper cover body through the avoidance hole, and the first heat insulation member is disposed at the mounting position and positioned between the heating element and the upper cover body, and is capable of shielding a part of the temperature limiter extending above the upper cover body along a horizontal direction.

The electric heating apparatus according to non-limiting embodiments of the present disclosure has at least the following beneficial effects: when in use, the temperature limiter is electrically connected to the heating element, the part that the temperature limiter is used for temperature detection extends above the upper cover body through the avoidance hole to detect the temperature of a cooking cavity of the cooking device. The difference between the temperature detected by the temperature limiter and the actual temperature of the cooking cavity can be reduced by extending a temperature measuring end of the temperature limiter above the upper cover body, and it is beneficial to improving the accuracy of temperature detection, and moreover, the first heat insulation member is positioned between the heating element and the upper cover body. The extending part of the temperature limiter is shielded through the first heat insulation member along the horizontal direction, which can reduce the interference of the heating member on the temperature limiter and is helpful to ensure the normal work of the temperature limiter.

According to some non-limiting embodiments of the present disclosure, the first heat insulation member is in a cylindrical structure and enclosed at a periphery of the upper cover body, and an upper side of the first heat insulation member is higher than an upper end surface of the upper cover body.

According to some non-limiting embodiments of the present disclosure, an inner cylinder wall of the first heat insulation member is provided with a heat insulation material layer.

According to some non-limiting embodiments of the present disclosure, a gap is provided between the inner cylinder wall of the first heat insulation member and a peripheral wall of the upper cover body.

According to some non-limiting embodiments of the present disclosure, fixing brackets are provided on a peripheral side of the mounting base, the fixing brackets are connected to the heating element and used for supporting the heating element, a lower side of the first heat insulation member is provided with plug-in slots, and the first heat insulation member is in plug-in fit with the fixing brackets through the plug-in slots.

According to some non-limiting embodiments of the present disclosure, three fixing brackets are provided and arranged around the periphery of the mounting base, and three plug-in slots are provided correspondingly to the fixing brackets.

According to some non-limiting embodiments of the present disclosure, a side wall of the mounting base is provided with plug-in holes, the fixing brackets are correspondingly provided with plug-in pins fitting with the plug-in holes, and the fixing brackets are fixedly connected to the peripheral side of the mounting base through a plug-in fit between the plug-in pins and the pin-in holes.

According to some non-limiting embodiments of the present disclosure, the electric heating apparatus further includes a second heat insulation member that is disposed on an upper side of the upper cover body, and the second heat insulation member is in a cylindrical structure and enclosed at a periphery of the extended part of the temperature limiter.

According to some non-limiting embodiments of the present disclosure, a gap is provided between the inner cylinder wall of the second heat insulation member and the peripheral wall of the extended part of the temperature limiter.

The cooking device according to a non-limiting embodiment in a second non-limiting aspect of the present disclosure includes the electric heating apparatus according to the embodiment in the first aspect of the present disclosure.

The cooking device according to non-limiting embodiments of the present disclosure has at least the following beneficial effects: by using the above-mentioned electric heating apparatus, the temperature limiter thereof can extend above the upper cover body for temperature detection and reduce the interference of the heating element on the temperature limiter through the first heat insulation member. It is beneficial to improving the accuracy of temperature detection, ensures the normal work of the temperature limiter, achieves a more reliable temperature control effect, and is easy to use.

Additional aspects and advantages of the present disclosure will be set forth in part in the description which follows, and in part will be obvious from the description, or may be learned by practice of the present disclosure.

### BRIEF DESCRIPTION OF THE DRAWINGS

The above and/or additional aspects and advantages of the present disclosure will become apparent and readily understood from the description of the non-limiting embodiments taken in conjunction with the following drawings, in which:

FIG. 1 is a schematic structural view of an electric heating apparatus according to a non-limiting embodiment of the present disclosure;

FIG. 2 is a schematic structural view of an electric heating apparatus in FIG. 1 from another perspective;

FIG. 3 is a schematic view of the exploded structure of an electric heating apparatus in FIG. 1;

FIG. 4 is a schematic cross-sectional structural view of an electric heating apparatus in FIG. 1; and

FIG. 5 is a schematic enlarged view of part A in FIG. 4.

### DETAILED DESCRIPTION

The non-limiting embodiments of the present disclosure are described in detail below, the example of the non-limiting embodiments is shown in the drawings, and from beginning to end, the same or similar signs indicate the same or similar components or components with same or similar function. The embodiment described with reference to the drawings is exemplary, which is merely used to explain the present disclosure, instead of being understood as a limitation to the present disclosure.

In the description of the present disclosure, it is understood that orientation or position relationships indicated by the terms “upper”, “lower”, “front”, “rear”, “left”, and “left”, and the like are based on the orientation or position relationships as shown in the drawings, for ease of describing the present disclosure and simplifying the description only, rather than indicating or implying that the mentioned apparatus or element necessarily has a particular orientation and must be constructed and operated in the particular orientation. Therefore, these terms should not be understood as limitations to the present disclosure.

In the description of the utility model, if “a plurality”, “greater than”, “less than”, “exceeding”, “above”, “below”, “within” and the like occur, the meaning of “several” is one or more, the meaning of “a plurality” is more than two, “greater than”, “less than”, “exceeding” and the like are understood as excluding the specified number, and “above”, “below”, “within” and the like are understood as including the specified number.

The described “first” and “second” are merely used for distinguishing technical features, instead of being understood as indicating or implying relative importance or impliedly indicating the quantity of the showed technical features or impliedly indicating the precedence relationship of the showed technical features.

In the description of the present disclosure, unless specific limitation otherwise, terms “set”, “install”, “join” and the like should be generally understood. Those of ordinary skill in the art may reasonably determine the specific meaning of the terms in the present disclosure in combination with the specific contents of the technical solution.

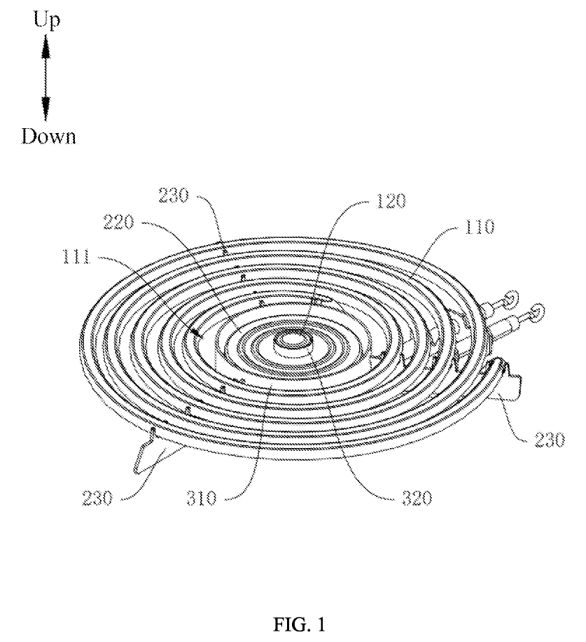

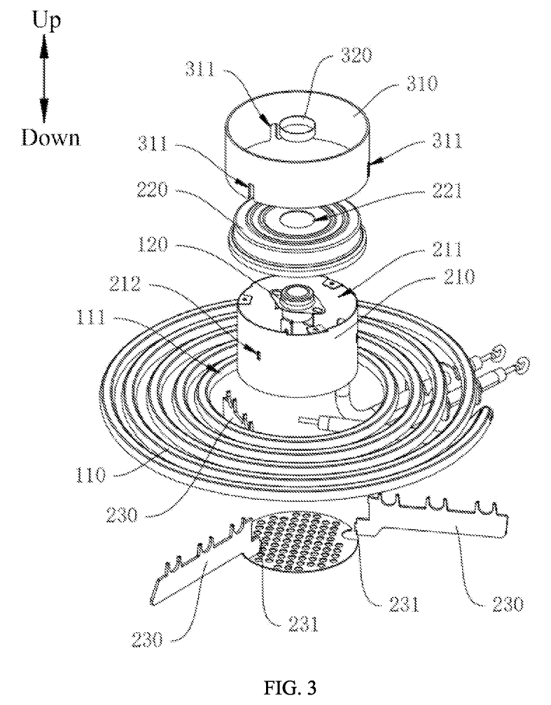

Referring to FIGS. 1 to 5, an electric heating apparatus includes a heating element 110, a mounting base 210, a temperature limiter 120 and a first heat insulation member 310, where a middle part of the heating element 110 is provided with a mounting position111. The mounting base 210 is disposed at the mounting position 111 and has a mounting inner cavity 211, and an upper side cover of the mounting base 210 is provided with an upper cover body 220. The temperature limiter 120 is fixedly connected to the upper cover body 220 or the mounting base 210, the upper cover body 220 is provided with a avoidance hole 221 corresponding to the temperature limiter 120. The temperature limiter 120 is partially positioned in the mounting inner cavity 211 and partially extends above the upper cover body 220 through the avoidance hole 221. The first heat insulation member 310 is disposed at the mounting position 111 and positioned between the heating element 110 and the upper cover body 220, and is capable of shielding a part of the temperature limiter 120 extending above the upper cover body 220 along a horizontal direction.

It could be understood that, as shown in FIGS. 1, 3 and 4, the heating element 110 is in a coil structure and has the mounting position 111 at the center thereof. The mounting base 210, the upper cover body 220, the temperature limiter 120 and the first heat insulation member 310 are all positioned in the mounting position 111. The upper cover body 220 is covered on the upper side of the mounting base 210, the temperature limiter 120 is fixedly connected to the upper cover body 220, and the lower part of the temperature limiter 120 is positioned in the mounting cavity 211 while the upper part is a temperature measuring end for detecting temperature and extends above the upper cover body 220 through the avoidance hole 221. The first heat insulation member 310 is positioned between the heating element 110 and the upper cover body 220 and can shield the part of the temperature limiter 120 extending above the upper cover body 220 along the horizontal direction. When in use, the temperature limiter 120 is electrically connected to the heating element 110, and the temperature measuring end of the temperature limiter 120 extends above the upper cover body 220 through the avoidance hole 221 to detect the temperature of a cooking cavity of the cooking device. Since the temperature measuring end of the temperature limiter 120 is exposed above the upper cover body 220, the difference between the temperature detected by the temperature limiter 120 and the actual temperature of the cooking cavity can be reduced, which is beneficial to improving the accuracy of temperature detection. Moreover, the extended part of the temperature limiter 120 is shielded through the first heat insulation member 310 along the horizontal direction, which can reduce the interference of the heating member 110 on the temperature limiter 120, is beneficial to ensuring the normal work of the temperature limiter 120 and achieves a more reliable temperature control effect.

In an actual application, the temperature limiter 120 can also be fixedly connected to the mounting base 210. The specific structures of the mounting base 210, the first heat insulation member 310 and other components can be set according to actual use needs, and will not be described in detail here. Details will be given below.

In some non-limiting embodiments, the first heat insulation member 310 is in a cylindrical structure and enclosed at a periphery of the upper cover body 220, and an upper side of the first heat insulation member 310 is higher than an upper end surface of the upper cover body 220.

It could be understood that, as shown in FIGS. 1, 2, 3 and 4, the first heat insulation member 310 is in a cylindrical structure penetrating up and down, and the first heat insulation member 310 is enclosed at the periphery of the upper cover body 220 and an upper side thereof is higher than an upper end surface of the upper cover body 220, to shield the extended part of the temperature limiter 120 in the horizontal direction and reduce the heat transfer from the heating element 110 to the extended part of the temperature limiter 120, thereby achieving the better anti-interference effect. In an actual application, the specific structure of the first heat insulation member 310 can also be set according to actual use needs.

Further, the inner cylinder wall of the first heat insulation member 310 is provided with a heat insulation material layer (not shown in the figures). It could be understood that the inner cylinder wall of the first thermal insulating member 310 can achieve a better heat insulation effect by providing the heat insulation material layer, thus further reducing the interference of the heating element 110 on the temperature limiter 120. In an actual application, the peripheral wall of the first heat insulation member 310 can also be provided with a reflecting layer in addition to providing the heat insulation material layer, the interference of the heating element 110 on the temperature limiter 120 is reduced in a manner of reflecting heat radiation, and the reflecting layer can be set specifically and according to actual use needs.

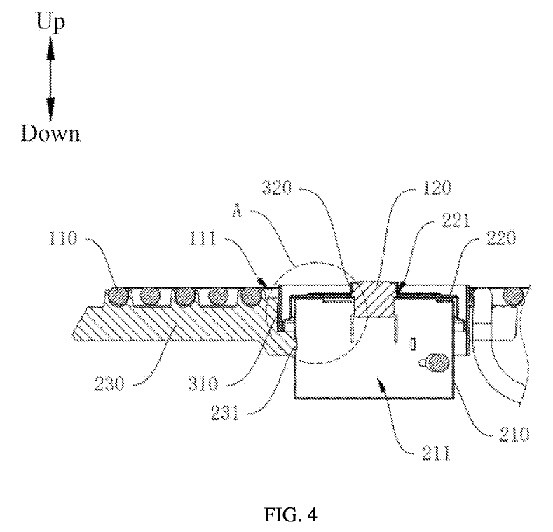

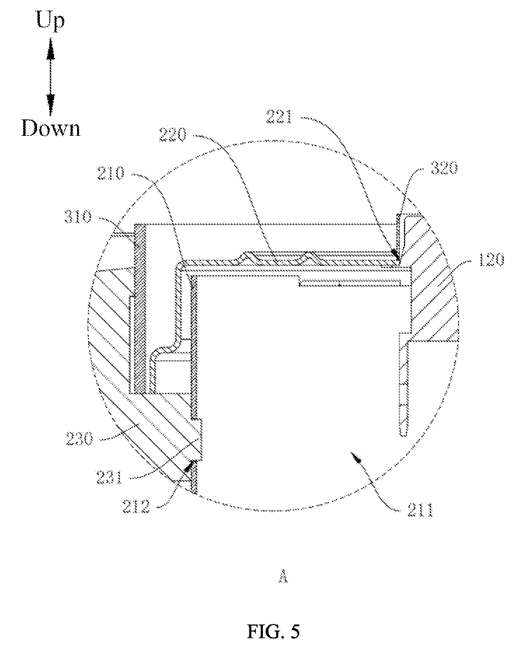

Further, a gap is provided between the inner cylinder wall of the first heat insulation member 310 and the peripheral wall of the upper cover body 220. It could be understood that, as shown in FIGS. 4 and 5, due to the gap between the inner cylinder wall of the first heat insulation member 310 and the peripheral wall of the upper cover body 220, the first heat insulation member 310 is not in contact with the upper cover body 220, which is beneficial to reducing heat transmission between the first heat insulation member 310 and the upper cover body 220, thereby reducing interference on the temperature limiter 120 for ease of use. In an actual application, a heat insulation material can also be provided between the inner cylinder wall of the first heat insulation member 310 and the peripheral wall of the upper cover body 220, and the specific gap size between the inner cylinder wall of the first heat insulation member 310 and the peripheral wall of the upper cover body 220 can be set according to actual use needs.

In some non-limiting embodiments, fixing brackets 230 are provided on the peripheral side of the mounting base 210, the fixing brackets 230 are connected to the heating element 110 and used for supporting the heating element 110, a lower side of the first heat insulation member 310 is provided with plug-in slots 311, and the first heat insulation member 310 is in plug-in fit with the fixing brackets 230 through the plug-in slots 311.

It could be understood that, as shown in FIGS. 1, 2, 3 and 4, the fixing brackets 230 are sheet-like structures and fixedly connected to the peripheral side of the mounting base 210 for connecting with the heating element 110 and supporting the coil part of the heating element 110. A lower side of the first heat insulation member 310 is provided with the plug-in slots 311, the installation of the first heat insulation member 310 is achieved through the plug-in fit between the plug-in slots 311 and the fixing brackets 230, and the plug-in slots 311 are simple in structure and convenient for assembling and disassembling the first heat insulation member 310. In an actual application, in addition to the above-mentioned structure, the first heat insulation member 310 can also be mounted and connected to the fixing brackets 230 or the mounting base 210 through a threaded structure, and the corresponding change can be specifically made according to actual use needs.

In some non-limiting embodiments, three fixing brackets 230 are provided and arranged around the periphery of the mounting base 210, and three plug-in slots 311 are provided correspondingly to the fixing brackets 230. It could be understood that, as shown in FIGS. 1, 2 and 3, the three fixing brackets 230 are all evenly spaced at the periphery of the mounting base 210, the three plug-in slots 311 are accordingly provided on the lower side of the first heat insulation member 310, the three plug-in slots 311 are in plug-in fit with the three fixing brackets 230 respectively, and the mounting position 111 of the first heat insulation piece 310 can be better fixed through the three-point plugging and fixing method, so as to avoid its horizontal movement and rotation and improve the stability and reliability. In an actual application, the specific number of fixing brackets 230 and plug-in slots 311 can also be changed according to actual use needs.

In some non-limiting embodiments, a side wall of the mounting base 210 is provided with plug-in holes 212, the fixing brackets 230 are correspondingly provided with plug-in pins 231 fitting with the plug-in holes 212, and the fixing brackets 230 are fixedly connected to the peripheral side of the mounting base 210 through a plug-in fit between the plug-in pins 231 and the pin-in holes 212.

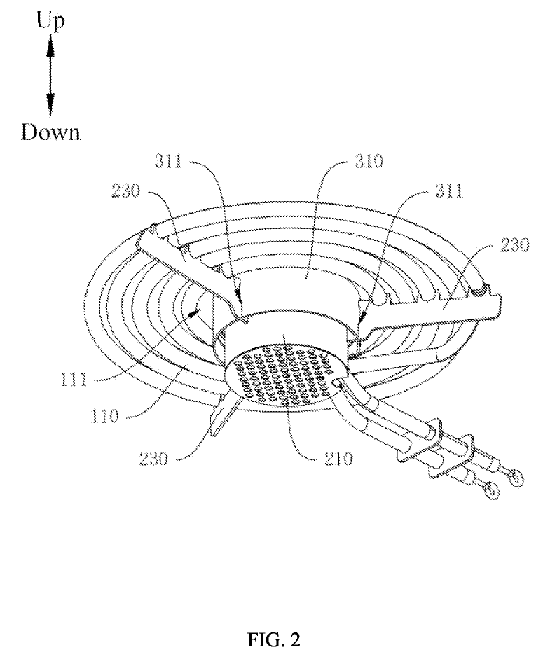

It could be understood that, as shown in FIGS. 2, 3, 4 and 5, the side wall of the mounting base 210 is provided with the plug-in holes 212, and one sides of the fixing brackets 230 that are close to the mounting base 210 are correspondingly provided with the plug-in pins 231. During installation, the plug-in pins 231 are in plug-in fit with the plug-in holes 212 so as to achieve the connection and fixation between the fixing brackets 230 and the mounting base 210, and the plug-in holes 212 are simple in structure and convenient for assembling and disassembling the fixing brackets 230. In an actual application. In addition to the above-mentioned structure, the fixing brackets 230 can also be mounted and connected to the mounting base 210 through a threaded structure, or the fixing brackets 230 can be fixed to the peripheral side of the mounting base 210 through welding, and the fixing brackets 230 can be specifically and accordingly set according to the actual use needs.

In some non-limiting embodiments, the electric heating apparatus further includes a second heat insulation member 320 that is disposed on an upper side of the upper cover body 220, and the second heat insulation member 320 is in a cylindrical structure and enclosed at a periphery of the extended part of the temperature limiter 120.

It could be understood that, as shown in FIGS. 1, 3, 4 and 5, the second heat insulation member 320 is in a cylindrical structure penetrating up and down, provided on the upper side of the upper cover body 220 and enclosed at the periphery of the extended part of the temperature limiter 120, thereby shielding the peripheral side of the extended part of the temperature limiter 120, further reducing the heat transfer from the heating element 110 to the extended part of the temperature limiter 120, and improving the anti-interference effect. In an actual application, the second heat insulation member 320 can be set according to actual use needs.

Further, a gap is provided between the inner cylinder wall of the second heat insulation member 320 and the peripheral wall of the extended part of the temperature limiter 120. It could be understood that, as shown in FIGS. 4 and 5, due to the gap between the inner cylinder wall of the second heat insulation member 320 and the peripheral wall of the extended part of the temperature limiter 120, the second heat insulation member 320 is not in contact with the extended part of the temperature limiter 120, which is beneficial to reducing heat transmission between the second heat insulation member 320 and the extended part of the temperature limiter 120, thereby reducing interference on the temperature limiter 120 for ease of use. In an actual application, with reference to the first heat insulation member 310, a heat insulation material layer is provided on the inner cylinder wall of the second heat insulation member 320, and the specific gap size between the inner cylinder wall of the second heat insulation member 320 and the peripheral wall of the extended part of the temperature limiter 120 can be set according to actual use needs.

The cooking device according to a non-limiting embodiment in a second non-limiting aspect of the present disclosure includes the electric heating apparatus according to the above-mentioned embodiment in the first aspect of the present disclosure.

According to the cooking device in non-limiting embodiments of the present disclosure, by using the above-mentioned electric heating apparatus, the temperature limiter 120 thereof can extend above the upper cover body 220 for temperature detection and reduce interference of the heating element 110 on the temperature limiter 120 through the first heat insulation member 310, which is beneficial to improving the accuracy of temperature detection and ensuring the normal work of the temperature limiter 120, achieves a reliable temperature control effect, and is easy to use.

Other compositions for the cooking device in the non-limiting embodiments of the present disclosure are known by those skilled in the art now or in the future, and detailed descriptions are not made here.

The embodiments of the present disclosure are described in detail above in combination with the accompanying drawings, and however the present disclosure is not limited the above embodiments. Under the premise of not departing from the gist of the present disclosure, various modifications may also be made within the knowledge scope of those skilled in the art.

What is claimed is:

1. An electric heating apparatus, comprising:
a heating element, wherein a middle part of the heating element is provided with a mounting position;
a mounting base disposed at the mounting position and having a mounting inner cavity, and the mounting base being provided with an upper cover body at an upper side cover of the mounting base;
a temperature limiter configured to fixedly connect to the upper cover body or the mounting base, wherein the upper cover body is provided with an avoidance hole corresponding to the temperature limiter, the temperature limiter is partially positioned in the mounting inner cavity and partially extends above the upper cover body through the avoidance hole; and
a first heat insulation member disposed at the mounting position and positioned between the heating element and the upper cover body, and the first heat insulation member being capable of shielding a part of the temperature limiter extending above the upper cover body along a horizontal direction.

2. The electric heating apparatus according to claim 1, wherein the first heat insulation member is in a cylindrical structure and enclosed at a periphery of the upper cover body, and an upper side of the first heat insulation member is higher than an upper end surface of the upper cover body.

3. The electric heating apparatus according to claim 2, wherein an inner cylinder wall of the first heat insulation member is provided with a heat insulation material layer.

4. The electric heating apparatus according to claim 2, wherein a gap is provided between the inner cylinder wall of the first heat insulation member and a peripheral wall of the upper cover body.

5. The electric heating apparatus according to claim 2, wherein fixing brackets are provided on a peripheral side of the mounting base, the fixing brackets are connected to the heating element and used for supporting the heating element, a lower side of the first heat insulation member is provided with plug-in slots, and the first heat insulation member is in plug-in fit with the fixing brackets through the plug-in slots.

6. The electric heating apparatus according to claim 5, wherein three fixing brackets are provided and arranged around the periphery of the mounting base, and three plug-in slots are provided correspondingly to the fixing brackets.

7. The electric heating apparatus according to claim 5, wherein a side wall of the mounting base is provided with plug-in holes, the fixing brackets are correspondingly provided with plug-in pins fitting with the plug-in holes, and the fixing brackets are fixedly connected to the peripheral side of the mounting base through a plug-in fit between the plug-in pins and the pin-in holes.

8. The electric heating apparatus according to claim 1, further comprising a second heat insulation member, wherein the second heat insulation member is disposed on an upper side of the upper cover body, and the second heat insulation member is in a cylindrical structure and enclosed at a periphery of the extended part of the temperature limiter.

9. The electric heating apparatus according to claim 8, wherein a gap is provided between the inner cylinder wall of the second heat insulation member and the peripheral wall of the extended part of the temperature limiter.

10. A cooking device, comprising the electric heating apparatus according to claim 1.
